(19) United States
(12) Patent Application Publication
(10) Pub. No.: US 2026/0227326 A1
(43) Pub. Date: Aug. 6, 2026

(54) GAS SENSOR BASED ON NON-DISPERSIVE INFRARED DETECTION

(71) Applicant: Shenzhen MEMSFrontier Electronics Co., Ltd., Shenzhen (CN)

(72) Inventors: Min Deng, Shenzhen (CN); Bin Wu, Shenzhen (CN)

(21) Appl. No.: 19/530,408

(22) Filed: Feb. 5, 2026

(30) Foreign Application Priority Data
Feb. 5, 2025 (CN) 202510128357.6

(51) Int. Cl. G01N 21/3504; G01N 21/01

(52) U.S. Cl. CPC G01N 21/3504; G01N 21/01

(57) ABSTRACT

Disclosed is an NDIR gas sensor including a base, a tube cap, at least one infrared source module, and at least one detection module. The tube cap covers the base, to which the outer edge is fixed. At least one base through hole is provided. The side wall of each base through hole extends away from the tube cap to form a tube core. Each infrared source module is mounted at the tube cap facing end of the base through hole to which a cavity in the infrared source module is connected. An air hole is provided on each tube core wall. Pins pass through the base to one side of the infrared source module. A detection module is assembled and seals each tube core end away from the infrared source module. This design integrates an absorption gas chamber with a back-emitting infrared source module, enhancing system robustness and stability.

### CROSS-REFERENCE TO RELATED APPLICATIONS

The present application claims the benefit of Chinese Patent Application No. 202510128357.6 filed on Feb. 5, 2025, the contents of which are incorporated herein by reference in their entirety.

### TECHNICAL FIELD

The present application relates to the field of sensor technology, and in particular to a gas sensor based on non-dispersive infrared detection.

### BACKGROUND

In recent years, non-dispersive infrared (NDIR) gas sensing technology has been widely used in many fields such as air quality testing, medical breath diagnosis, smart agriculture, and industrial process gas monitoring. Most existing NDIR gas sensors are product modules assembled from discrete components through integration and encapsulation processes, presenting great challenges in terms of product consistency and miniaturization. Furthermore, stability and robustness of these products need to be further improved. In addition, for some special application scenarios, such as wide-range gas monitoring and mixed multi-gas detection, there is still a lack of highly stable and robust design solutions.

Generally, an NDIR gas sensor is composed of an infrared source, an absorption gas chamber, an infrared detector, and a circuit board. A reflector, the infrared source, and the infrared detector are welded on the circuit board, fixed at both ends of the absorption gas chamber, and sealed and encapsulated with sealing glue. Its overall structure and production process are complex, making it difficult to achieve mass production while ensuring high reliability. This non-integrated structural design results in sensors with poor stability and robustness, often accompanied by unsatisfactory consistency and miniaturization, and urgently needs to be further improved. Moreover, most current NDIR gas sensors employ a dual-channel, fixed optical path design, resulting in a narrow concentration detection range, and a single sensor cannot detect gases across both high and low ranges. In terms of mixed multi-gas detection, an NDIR gas sensor is generally assembled from one or more infrared sources and one or more infrared detectors, which has disadvantages such as complex structure, poor robustness, and large size.

### SUMMARY

Embodiments of the present application provide a gas sensor based on NDIR detection, aiming to solve the problems of complex structure, poor robustness, and large volume of gas sensors in the prior art.

The embodiments of the present application provide a gas sensor based on NDIR detection, which includes a base, a tube cap, at least one detection module, and at least one infrared source module; in which
the tube cap covers the base, and the outer edge of the tube cap is fixedly connected to the base; the base is provided with at least one base through hole penetrating the base; and the side wall of each of the base through holes extends away from the tube cap to form a hollow tube core;
each of the infrared source modules covers and is arranged at the end of the base through hole facing the tube cap, and a cavity in the infrared source module is connected to one of the base through holes; and an air hole is provided on the wall of each of the tube cores; pins pass through the base, and ends of the pins extend into one side of the infrared source module, in which a heating layer in the infrared source module is electrically connected to the ends of the pins by metal wires; and
each of the detection modules is assembled at the end of one of the tube cores away from the infrared source module, and seals the end of the tube core; each of the detection modules is provided with at least one infrared detector, and each of the infrared detectors is provided with a narrowband filter at the end facing the infrared source module; and detection pins electrically connected to each of the infrared detectors extend from the inside of the detection module to the outside thereof.

For the gas sensor based on NDIR detection, the infrared source module is a silicon-based MEMS light source module, a heating metal foil, or a metal wire; and
one side of the silicon-based MEMS light source module facing the base through hole is recessed inward to form the cavity; the tube cap is an arc-shaped tube cap with one side open, and the opening of the arc-shaped tube cap faces the base.

For the gas sensor based on NDIR detection, the silicon-based MEMS light source module mainly includes a silicon substrate, a heating layer, and a reflective layer; and
the silicon substrate is provided with a substrate through hole, the heating layer is attached to one side of the silicon substrate away from the base and covers the substrate through hole to form an inwardly recessed cavity, and the reflective layer is attached to an upper layer of the heating layer.

For the gas sensor based on NDIR detection, the reflective layer is a metal reflective film made of one or more materials selected from the group consisting of Au, Pt, Ag, Al, and Cu.

For the gas sensor based on NDIR detection, the infrared source module is a double-sided silicon-based MEMS light source module, a double-sided silicon-based heating metal wire, or a double-sided ceramic-based heating metal wire;
the double-sided silicon-based MEMS light source module is provided with a cavity penetrating therethrough in an upper-to-lower direction; and the tube cap is a tubular cap with openings at both ends;
an end of the tube cap away from the base is provided with one or more openings, and each of the openings at an end of the tubular cap away from the base is provided with a detection module; and
a metal-coated pad is provided between the double-sided silicon-based MEMS light source module and the base, in which the metal-coated pad is electrically connected to the heating layer of the double-sided silicon-based MEMS light source module on one side close to the base, and is electrically connected to the end of the pins through a metal wire.

For the gas sensor based on NDIR detection, the double-sided silicon-based MEMS light source module mainly includes a silicon substrate, two heating layers, and two infrared radiation material layers; and
the silicon substrate is provided with a substrate through hole, the two heating layers are respectively attached to two sides of the silicon substrate; the two infrared radiation material layers are respectively attached to outer side surfaces of the two heating layers, and the heating layers located at both ends of the substrate through hole and the infrared radiation material layers on which the heating layers are attached are combined into an infrared radiation unit, in which the infrared radiation unit is suspended at an outer opening of the substrate through hole, and the heating layers in the infrared radiation unit extend outward and form a support arm connected to the heating layers at the outer edge of the substrate through hole.

For the gas sensor based on NDIR detection, each of the infrared radiation material layers is a nano-platinum black layer, nano-black silicon layer, carbon nanotube layer, graphene layer, amorphous carbon film doped with metal elements, Au/Al₂O₃/Au metasurface material layer, or ZnNiP chemical plating.

For the gas sensor based on NDIR detection, the silicon substrate is a monocrystalline silicon substrate or an SOI substrate.

For the gas sensor based on NDIR detection, the heating layer includes a support layer, a heating electrode, and an isolation layer that are arranged in a stacked manner; the heating electrode is a metal composite film layer made of one or more materials, including Pt, Au, W, Al, tin nitride, nickel-chromium alloy, and MoSi₂, or a polycrystalline silicon film doped with B by ion implantation; and
the support layer and the isolation layer can be a SiO₂ layer, a Si₃N₄ layer, a SiNₓ layer, or a composite film layer formed by multiple film layers selected from the group consisting of a SiO₂ layer, a Si₃N₄ layer, and a SiNₓ layer.

For the gas sensor based on NDIR detection, inner and outer surfaces of the base are electroplated with a metal film layer, and the metal film layer is made of one or more materials selected from the group consisting of Ni, Au, Al, and Pt.

The embodiments of the present application provide a gas sensor based on NDIR detection, which includes a base, a tube cap, at least one detection module, and at least one infrared source module; the tube cap covers the base, and the outer edge of the tube cap is fixedly connected to the base; the base is provided with at least one base through hole penetrating the base; and the side wall of each of the base through holes extends away from the tube cap to form a hollow tube core; each of the infrared source modules covers and is arranged at the end of the base through hole facing the tube cap, and a cavity in the infrared source module is connected to one of the base through holes; and an air hole is provided on the wall of each of the tube cores; pins pass through the base, and ends of the pins extend into one side of the infrared source module, wherein a heating layer in the infrared source module is electrically connected to the ends of the pins by metal wires; and each of the detection modules is assembled at the end of one of the tube cores away from the infrared source module, and seals the end of the tube core. The above-mentioned gas sensor is designed based on an absorption gas chamber integrated structure and a back-emitting infrared source module, and no other structure is required to fix the infrared source module. This effectively reduces the integration difficulty and volume of the sensor and greatly enhances its stability and system robustness.

### BRIEF DESCRIPTION OF DRAWINGS

To illustrate technical solutions in embodiments of the present application more clearly, drawings to be used for describing the embodiments are introduced briefly in the following. Apparently, the drawings in the following description are some embodiments of the present application, and persons of ordinary skill in the art may derive other drawings from these drawings without creative efforts.

FIG. 1 is a cross-sectional view of a structure of a gas sensor based on NDIR detection according to an embodiment of the present application;

FIG. 2 is another cross-sectional view of a structure of a gas sensor based on NDIR detection according to an embodiment of the present application;

FIG. 3 is also another cross-sectional view of a structure of a gas sensor based on NDIR detection according to an embodiment of the present application;

FIG. 4 is still another cross-sectional view of a structure of a gas sensor based on NDIR detection according to an embodiment of the present application;

FIG. 5 is a cross-sectional view of a structure of an infrared source module according to an embodiment of the present application;

FIG. 6 is another cross-sectional view of a structure of an infrared source module according to an embodiment of the present application; and

FIG. 7 is a three-dimensional view of a structure of a base according to an embodiment of the present application.

Reference numerals: 3. base; 6. tube cap; 4. detection module; 1. silicon-based MEMS light source module; 2. double-sided silicon-based MEMS light source module; 11. silicon substrate; 101. cavity; 12. heating layer; 13. reflective layer; 21. infrared radiation material layer; 31. tube core; 32. pin; 33. air hole; 41. infrared detector; 42. narrowband filter; 43. detection pin; 7. metal-coated pad; 8. metal wire.

### DETAILED DESCRIPTION OF THE EMBODIMENTS

The technical solutions in the embodiments of the present application will be clearly and completely described below with reference to the drawings in the embodiments of the present application. Obviously, the embodiments described are only a part of, not all, the embodiments of the present application. Based on the embodiments described herein, all other embodiments obtained by those of ordinary skill in the art without creative work are within the scope of the present application.

It should be understood that when used in the specification and the claims of the present application, the terms “include” and “comprise” indicate the presence of the described features, wholes, steps, operations, elements, and/or components, but do not exclude the presence or addition of one or more other features, wholes, steps, operations, elements, components, and/or sets thereof.

It should further be understood that the terms used in the specification of the present application are used only for describing specific embodiments and are not intended to limit the present application. As used in the specification and the claims of the present application, “a”, “an”, and “the” representing a singular form are intended to include plural forms unless the context clearly indicates otherwise. It should further be understood that the term “and/or” used in the present application's specification and the claims refers to any combination of one or more of the associated listed items and all possible combinations, and includes these combinations.

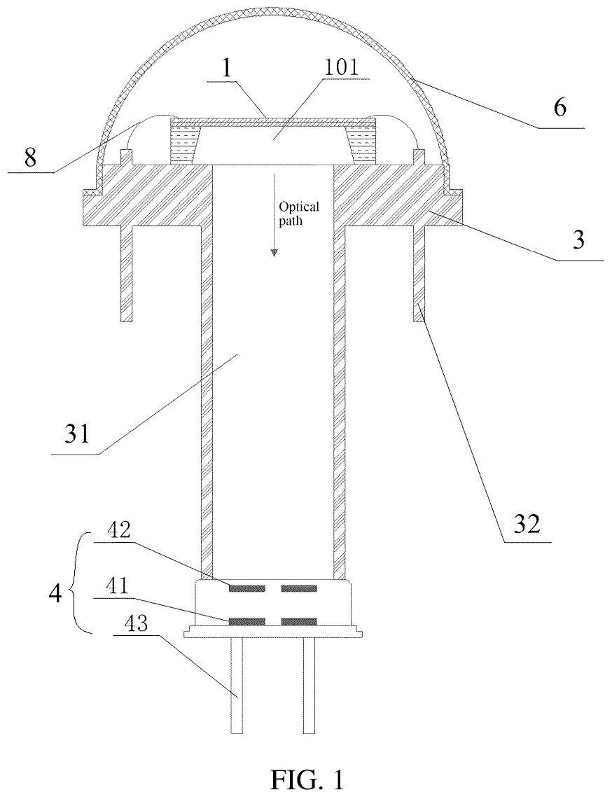

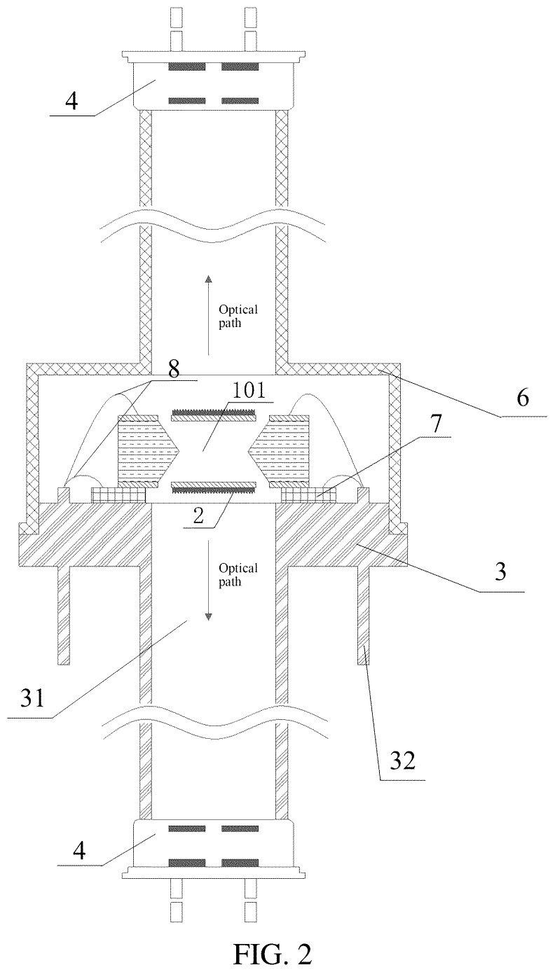

As shown in FIG. 1 and FIG. 2, the embodiments of the present application disclose a gas sensor based on NDIR detection, in which the gas sensor includes a base 3, a tube cap 6, at least one detection module 4, and at least one infrared source module; the tube cap 6 covers the base 3, and the outer edge of the tube cap 6 is fixedly connected to the base 3; the base 3 is provided with at least one base through hole penetrating the base 3; the side wall of each of the base through holes extends away from the tube cap 6 to form a hollow tube core 31; each of the infrared source modules covers and is arranged at the end of one of the base through holes facing the tube cap 6, and the cavity 101 in the infrared source module is connected to one of the base through holes; an air hole 33 is provided on the wall of each of the tube cores 31; pins 32 pass through the base 3 and ends of the pins 32 extend into one side of the infrared source module, in which a heating layer 12 in the infrared source module is electrically connected to the ends of the pins 32 by metal wires 8; each of the detection modules 4 is assembled at the end of one of the tube cores 31 away from the infrared source module, and seals the end of the tube core 31; each of the detection modules 4 is provided with at least one infrared detector 41 is provided, and each of the infrared detectors 41 is provided with a narrowband filter 42 at the end facing the infrared source module; and detection pins 43 electrically connected to each of the infrared detectors 41 extend from the inside of the detection module 4 to the outside.

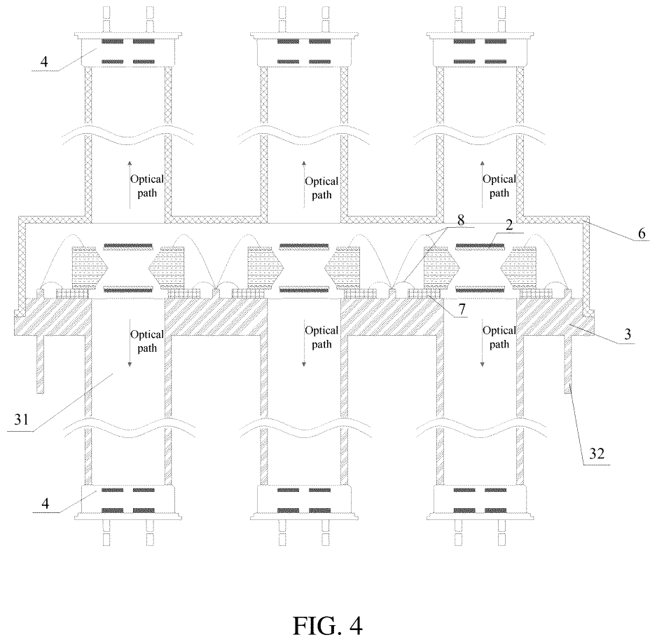

The tube cap 6 covers the base 3, and one or more base through holes can be set on the base 3. The side wall of each base through hole extends away from the tube cap 6 to form a hollow tube core 31. As shown in FIG. 1, a base through hole is set on the base 3, and the base through hole extends to form the tube core 31. Each base through hole is covered with an infrared source module at the end facing the tube cap 6. FIGS. 1, 2, and 3 show that an infrared source module is mounted at one end of a base through hole, and FIG. 4 shows that multiple infrared source modules are mounted at one end of multiple base through holes. A detection module 4, including at least one infrared detector 41 and at least one narrowband filter 42, is mounted at the end of the tube core 31 away from the infrared source module. As shown in FIG. 1, two infrared detectors 41 and two narrowband filters 42 are mounted in the detection module 4.

Specifically, a step may be provided at the edge of the base 3, and the outer edge of the tube cap 6 may be embedded in the step, to achieve a fixed connection between the tube cap 6 and the base 3. The pins 32 provided on the base 3 are used to realize the electrical connection of the infrared source module. The size of the base 3 can be designed and processed according to actual needs, and the inner diameter and outer diameter of the tube core 31 need to be determined according to the size of the infrared source module. The diameter of the metal wire 8 is 15 μm-50 μm.

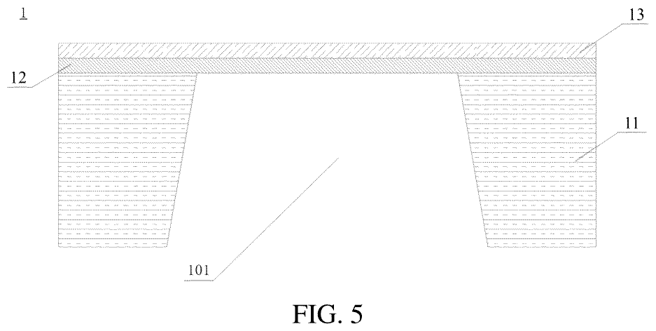

In a specific embodiment, the infrared source module is a silicon-based MEMS light source module 1, a heating metal foil, or a metal wire; the side of the silicon-based MEMS light source module 1 facing the base through hole is recessed inward to form the cavity 101; and the tube cap 6 is an arc-shaped tube cap 6 with one side open, and the opening of the arc-shaped tube cap 6 faces the base 3. Specifically, as shown in FIG. 5, the silicon-based MEMS light source module 1 mainly includes a silicon substrate 11, a heating layer 12, and a reflective layer 13. The silicon substrate 11 is provided with a substrate through hole, the heating layer 12 is attached to the side of the silicon substrate 11 away from the base 3 and covers the substrate through hole to form an inwardly recessed cavity 101, and the reflective layer 13 is attached to the upper layer of the heating layer 12. The reflective layer 13 is a metal reflective film made of one or more materials selected from the group consisting of Au, Pt, Ag, Al, and Cu.

As shown in FIG. 1, the tube cap 6 is an arc-shaped tube cap 6 with one side open, and only one detection module 4 is mounted at the end of a tube core 31 away from the infrared source module. The side of the silicon-based MEMS light source module 1 facing the base through hole is recessed inward to form the cavity 101, and the cavity 101 is connected to the base through hole. Specifically, the silicon-based MEMS light source module 1 includes a silicon substrate 11, a heating layer 12, and a reflective layer 13. The heating layer 12 electrothermally radiates infrared light. The infrared light is reflected by the enhanced reflection effect of the reflective layer 13 and is radiated outward from the cavity 101 of the silicon substrate 11, forming a back-emitting silicon-based MEMS infrared source. Specifically, the cavity 101 of the silicon substrate 11 can have a trapezoid or rectangle cross section, and the opening of the cavity 101 can be larger than the inner diameter of the tube core 31. This structural configuration of the back-emitting silicon-based MEMS infrared source can effectively reduce the difficulty of component integration and assembly.

The processing method of the silicon-based MEMS light source module 1 and the reflective layer 13 therein is not limited in the present application, and their sizes can be designed and processed according to actual needs. In addition, the silicon-based MEMS light source module 1 can be replaced by a heating metal foil or a metal wire to realize the application function of radiating infrared light outward based on the electrothermal principle.

In another specific embodiment, the infrared source module is a double-sided silicon-based MEMS light source module 2, a double-sided silicon-based heating metal wire, or a double-sided ceramic-based heating metal wire; the double-sided silicon-based MEMS light source module 2 is provided with a cavity 101 penetrating therethrough in an upper-to-lower direction; the tube cap 6 is a tubular cap 6 with openings at both ends; the end of the tube cap 6 away from the base 3 is provided with one or more openings, and each opening is provided with a detection module 4; and a metal-coated pad 7 is provided between the double-sided silicon-based MEMS light source module 2 and the base 3, and the metal-coated pad 7 is electrically connected to the heating layer 12 of the double-sided silicon-based MEMS light source module 2 on the side close to the base 3, and is electrically connected to the end of the pins 32 through a metal wire 8.

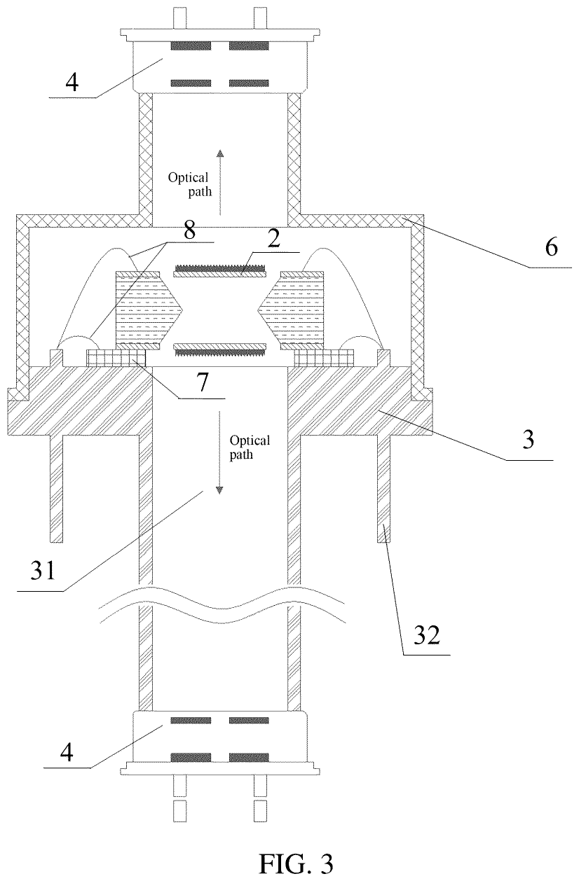

As shown in FIGS. 2 to 4, to further improve the ability to detect different gas components (for example simultaneous detection of nitric oxide and carbon dioxide), the infrared source module can be configured as a double-sided silicon-based MEMS light source module 2. The double-sided silicon-based MEMS light source module 2 is provided with a cavity 101 penetrating therethrough in an upper-to-lower direction, and the tube cap 6 is a tubular cap 6 with openings at both ends. At the end of the tube cap 6 away from the base 3, an opening can be set, as shown in FIGS. 2 and 3, and multiple openings can also be set, as shown in FIG. 4. Each of the openings at an end of the tubular cap 6 away from the base 3 is provided with a detection module 4. The metal-coated pad 7 is electrically connected to the heating layer 12 of the double-sided silicon-based MEMS light source module 2 on the side close to the base 3, and is electrically connected to the end of the pins 32 through the metal wire 8. The heating layer 12 of the double-sided silicon-based MEMS light source module 2 on the side away from the base 3 is directly electrically connected to the end of the pins 32 through the metal wire 8.

In addition, the double-sided silicon-based MEMS light source module 2 can also be replaced by a double-sided silicon-based heating metal wire or a double-sided ceramic-based heating metal wire to realize the application function of bidirectionally radiating infrared light to both ends based on the electrothermal principle.

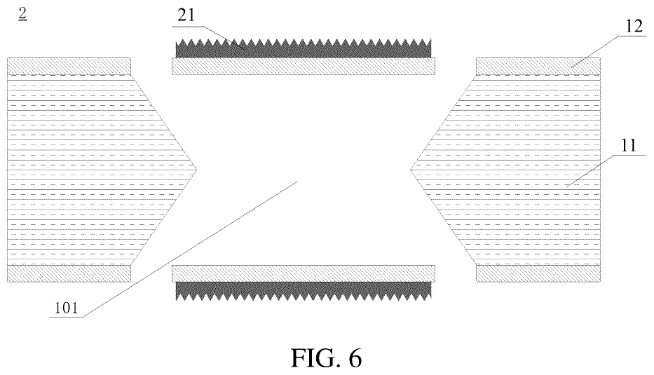

Specifically, as shown in FIG. 6, the double-sided silicon-based MEMS light source module 2 includes a silicon substrate 11, two heating layers 12, and two infrared radiation material layers 21; the silicon substrate 11 is provided with a substrate through hole; the two heating layers 12 are respectively attached to the two sides of the silicon substrate 11; the two infrared radiation material layers 21 are respectively attached to the outer side surfaces of the two heating layers 12; the heating layers 12 located at both ends of the substrate through hole and the infrared radiation material layers 21 on which the heating layers are attached are combined into an infrared radiation unit, which is suspended at an outer opening of the substrate through hole; and the heating layers 12 in the infrared radiation unit extend outward and form a support arm connected to the heating layers 12 at the outer edge of the substrate through hole. Each of the infrared radiation material layers 21 is a nano-platinum black layer, nano-black silicon layer, carbon nanotube layer, graphene layer, amorphous carbon film doped with metal elements, Au/Al₂O₃ or Au metasurface material layer, or ZnNiP chemical plating.

The double-sided silicon-based MEMS light source module 2 can be configured to include a silicon substrate 11, two heating layers 12, and two infrared radiation material layers 21. Then, the heating layers 12 located at the opening at both ends of the substrate through hole are attached to the infrared radiation material layers 21 to form an infrared radiation unit, that is, an infrared radiation unit is suspended at the opening at both ends of the substrate through hole. The heating layers 12 in the infrared radiation unit are connected to the heating layers 12 at the outer edge of the substrate through hole through the support arm, which is formed by extending the heating layers 12 in the infrared radiation unit outward. The heating layers 12 on both sides of the silicon substrate 11 radiate infrared light respectively. The infrared light, after being enhanced by the enhanced radiation effect of the infrared radiation material layers 21, is radiated outward from both sides of the silicon substrate 11, forming an infrared source with a double-sided radiation function. The double-sided silicon-based MEMS light source module 2 can effectively reduce the volume of NDIR gas sensors and simplify the infrared source module control circuit to achieve multi-gas detection. The cavity 101 in the silicon substrate 11 penetrating therethrough in an upper-to-lower direction is hourglass-shaped and symmetrically arranged along a center line parallel to the heating layers 12. The cross section of the cavity 101 is formed by two symmetrical trapezoids, as shown in FIG. 6.

Further, the openings at both ends of the cavity 101 can be larger than the inner diameter of the tube core 31, and the size of the infrared radiation unit can be smaller than the inner diameter of the tube core 31. The processing method of the double-sided silicon-based MEMS light source module 2 and the infrared radiation material layers 21 therein is not limited in the present application, and their sizes can be designed and processed according to actual needs.

In a more specific embodiment, the silicon substrate 11 is a monocrystalline silicon substrate 11 or an SOI wafer substrate. Specifically, the heating layer 12 includes a support layer, a heating electrode, and an isolation layer that are arranged in a stacked manner. The heating electrode is a metal composite film layer made of one or more materials selected from the group consisting of Pt, Au, W, Al, tin nitride, nickel-chromium alloy, and MoSi₂, or a polycrystalline silicon film doped with B by ion implantation. The support layer and the isolation layer can be a SiO₂ layer, a Si₃N₄ layer, a SiNₓ layer, or a composite film layer formed by multiple film layers selected from the group consisting of a SiO₂ layer, a Si₃N₄ layer, and a SiNₓ layer. Inner and outer surfaces of the base are electroplated with a metal film layer, and the metal film layer is made of one or more materials selected from the group consisting of Ni, Au, Al, and Pt.

The silicon substrate 11 is a monocrystalline silicon substrate 11 or an SOI wafer substrate. The base 3 can be made of cold rolled steel, stainless steel, or Kovar alloy. The inner and outer surfaces of the base 3 are electroplated with a metal film layer made of one or more materials selected from the group consisting of Ni, Au, Al, and Pt. The infrared detector 41 can be a thermopile, a pyroelectric sensor, or a bolometer. The tube cap 6 can be made of cold rolled steel, stainless steel, or Kovar alloy. The inner and outer surfaces of the tube cap 6 are electroplated with a metal film layer made of one or more materials selected from the group consisting of Ni, Au, Al, and Pt. The metal-coated pad 7 can be a silicon-based or ceramic-based pad with an evaporated metal film made of one or more materials selected from the group consisting of Au, Pt, Ag, Al, and Cu, on its surface.

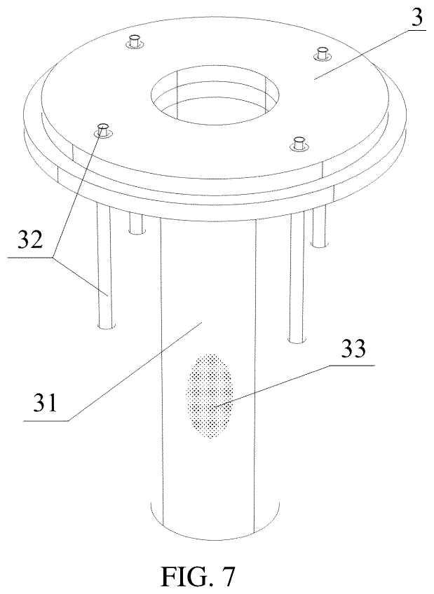

As shown in FIG. 7, positions corresponding to the base through holes on the base 3 extend outward to form hollow tube cores 31. The axes of the hollow tube cores 31 are parallel, and the inner and outer surfaces of the tube cores 31 are electroplated with an infrared-reflecting metal film layer. The side wall of each of the tube cores 31 is provided with an air hole 33, and the outer side of the air hole 33 is covered with a waterproof breathable membrane or is coated with a water vapor absorbing material, which can be quicklime or a super absorbent resin. Specifically, the metal film layer electroplated on the surface of the tube core 31 is made of one or more materials selected from the group consisting of Ni, Au, Al, and Pt, and the metal film layer can be electroplated on the inner and outer surfaces of the base 3. Using the tube core 31 with a hollow structure to replace an absorption gas chamber in the NDIR gas sensor module effectively reduces the number of discrete components in the sensor and improves processing efficiency and system stability and robustness.

In the specific processing and manufacturing process, as shown in FIG. 1, the silicon-based MEMS light source module 1 of the above-mentioned back-emitting structure can be die-attached to the base 3 through silver paste. The position of the silicon-based MEMS light source module 1 corresponds to the opening of the base through hole in the base 3. The metal wire 8 is used for wire bonding to achieve electrical connection between the silicon-based MEMS light source module 1 and the pins 32. The infrared-reflecting metal film layer can be electroplated on the inner surface of the arc-shaped tube cap 6, and the arc-shaped tube cap 6 is fixed to the base 3 by laser seal welding or electric resistance welding, and the silicon-based MEMS light source module 1 is encapsulated. In this process, an ordinary tube cap 6 without the infrared-reflecting metal film layer can also be used for packaging. A detection module 4 is provided at the end of the tube core 31 away from the silicon-based MEMS light source module 1 to form a micro NDIR gas sensor. The silicon-based MEMS light source module 1 radiates infrared light outward from the cavity 101, and the arc-shaped tube cap 6 ensures that the infrared light enters the tube core 31 to the greatest extent. The absorption of infrared light by a target gas entering the tube core 31 through the air hole 33 complies with the Lambert-Beer law: I=I₀e^{εCL} where I is the intensity of emitted light, I₀ is the intensity of incident light, ε is the molar absorption coefficient, C is the gas concentration, L is the effective gas chamber length, and e is the base of the natural logarithm. Based on the above principle, the concentration of the target gas can be detected. The integration of the base 3 of the above-mentioned absorption gas chamber integrated structure and the back-emitting silicon-based MEMS light source module assembly 1 yields an NDIR gas sensor with simple structure, high stability, and high robustness. This approach effectively reduces the integration difficulty and volumes of the sensors, and improves the processing efficiency and consistency of the sensors.

In the processing and manufacturing process of the sensor of another structure, as shown in FIGS. 2 to 4, the above-mentioned double-sided silicon-based MEMS light source module 2 can be die-attached to the base 3 through silver paste. The position of the silicon-based MEMS light source module 2 corresponds to the opening of the base through hole in the base 3. The metal wire 8 and the metal-coated pad 7 are used for wire bonding to achieve electrical connection between the double-sided silicon-based MEMS light source module 2 and the pins 32. The tubular cap 6 with an infrared-reflecting metal film layer on the inner surface is fixed to the base 3 by laser seal welding or electric resistance welding, and the double-sided silicon-based MEMS light source module 2 is encapsulated. A detection module 4 is provided at the end of the tube core 31 away from the double-sided silicon-based MEMS light source module 2, and at the same time, a detection module 4 is provided at each opening of the tubular cap 6 away from the double-sided silicon-based MEMS light source module 2, to form a micro NDIR mixed multi-gas sensor. The detection principle of the mixed multi-gas sensor obtained is the same as the above detection principle. The only difference is that the mixed multi-gas sensor can detect multiple different gases simultaneously, not just one gas, in terms of function.

As shown in FIG. 2 and FIG. 3, bases 3 with tube cores 31 of varying lengths and tubular caps 6 of varying lengths can be designed and processed to create absorption gas chambers with different optical path lengths. For example, the tubular cap 6 in FIG. 3 is shorter than that in FIG. 2. Then, the shorter tubular cap 6 in FIG. 3 is suitable for detecting high-concentration gases, while the longer tube core 31 can be used to detect low-concentration gases, thereby realizing a wide-range gas sensor based on NDIR detection. The detection principle is the same as above and will not be repeated here.

For more complex infrared gas detection scenarios, an array multi-channel structure can be adopted. As shown in FIG. 4, the base 3 with multiple tube cores 31 can be set, and multiple tubular channels can be set at the end of the tubular cap 6 away from the double-sided silicon-based MEMS light source module 2. Then, the number of tubular channels on the tubular cap 6 can be equal to the number of the tube cores 31 in the base 3. A detection module 4 is arranged at the end opening of each tubular channel, and multiple double-sided silicon-based MEMS light source modules 2 are used to realize multi-channel infrared gas detection. The detection principle is the same as above and will not be repeated here. The present application provides a design method with higher stability and robustness, smaller volume, simpler structure, and higher processing efficiency compared with the existing NDIR gas sensors.

The embodiments of the present application provide a gas sensor based on NDIR detection, which includes a base 3, a tube cap 6, at least one detection module 4, and at least one infrared source module; the tube cap 6 covers the base 3, and the outer edge of the tube cap 6 is fixedly connected to the base 3; the base 3 is provided with at least one base through hole penetrating the base 3; the side wall of each of base through holes extends away from the tube cap 6 to form a hollow tube core 31; each of the infrared source modules covers and is arranged at the end of one of the base through holes facing the tube cap 6, and the cavity 101 in the infrared source module is connected to one of the base through holes; an air hole 33 is provided on the wall of each of the tube cores 31; pins 32 pass through the base 3 and ends of the pins 32 extend into one side of the infrared source module, in which a heating layer 12 in the infrared source module is electrically connected to the ends of the pins 32 by metal wires 8; and each of the detection modules 4 is assembled at the end of a corresponding tube core 31 away from the infrared source module, and seals the end of the tube core 31. The above-mentioned gas sensor is designed based on an absorption gas chamber integrated structure and a back-emitting infrared source module, and no other structure is required to fix the infrared source. This makes the sensor structure simple and small, effectively reducing the manufacturing and integration difficulty of the sensor, and greatly enhancing its stability and system robustness.

The foregoing description is just the detailed embodiments to which, however, the protection scope of the present application is not limited. Equivalent modifications or alternatives which can be easily thought of by any technicians familiar with the field of the present application within the technical scope disclosed in the present application shall be also covered by the protection scope of the present application. Therefore, the protection scope of the present application shall be defined by the protection scope of the claims.

What is claimed is:

1. A gas sensor based on non-dispersive infrared (NDIR) detection, comprising a base, a tube cap, at least one detection module, and at least one infrared source module, wherein
the tube cap covers the base, and the outer edge of the tube cap is fixedly connected to the base; the base is provided with at least one base through hole penetrating the base; and the side wall of each of the base through holes extends away from the tube cap to form a hollow tube core;
each of the infrared source modules covers and is arranged at the end of the base through hole facing the tube cap, and a cavity in the infrared source module is connected to one of the base through holes; and an air hole is provided on the wall of each of the tube cores;
pins pass through the base, and ends of the pins extend into one side of the infrared source module, wherein a heating layer in the infrared source module is electrically connected to the ends of the pins by metal wires; and
each of the detection modules is assembled at the end of one of the tube cores away from the infrared source module, and seals the end of the tube core; each of the detection modules is provided with at least one infrared detector, and each of the infrared detectors is provided with a narrowband filter at the end facing the infrared source module; and detection pins electrically connected to each of the infrared detectors extend from the inside of the detection module to the outside thereof.

2. The gas sensor based on NDIR detection according to claim 1, wherein the infrared source module is a silicon-based MEMS light source module, a heating metal foil, or a metal wire; and
one side of the silicon-based MEMS light source module facing the base through hole is recessed inward to form the cavity, the tube cap is an arc-shaped tube cap with one side open, and the opening of the arc-shaped tube cap faces the base.

3. The gas sensor based on NDIR detection according to claim 2, wherein the silicon-based MEMS light source module comprises a silicon substrate, a heating layer, and a reflective layer; and
the silicon substrate is provided with a substrate through hole, the heating layer is attached to one side of the silicon substrate away from the base and covers the substrate through hole to form an inwardly recessed cavity, and the reflective layer is attached to an upper layer of the heating layer.

4. The gas sensor based on NDIR detection according to claim 3, wherein the reflective layer is a metal reflective film made of one or more materials selected from the group consisting of Au, Pt, Ag, Al, and Cu.

5. The gas sensor based on NDIR detection according to claim 1, wherein the infrared source module is a double-sided silicon-based MEMS light source module, a double-sided silicon-based heating metal wire, or a double-sided ceramic-based heating metal wire;
the double-sided silicon-based MEMS light source module is provided with a cavity penetrating therethrough in an upper-to-lower direction; and the tube cap is a tubular cap with openings at both ends;
an end of the tube cap away from the base is provided with one or more openings, and each of the openings at an end of the tubular cap away from the base is provided with a detection module; and
a metal-coated pad is provided between the double-sided silicon-based MEMS light source module and the base, wherein the metal-coated pad is electrically connected to the heating layer of the double-sided silicon-based MEMS light source module on one side close to the base, and is electrically connected to the end of the pins through a metal wire.

6. The gas sensor based on NDIR detection according to claim 5, wherein the double-sided silicon-based MEMS light source module comprises a silicon substrate, two heating layers, and two infrared radiation material layers; and
the silicon substrate is provided with a substrate through hole, the two heating layers are respectively attached to two sides of the silicon substrate; the two infrared radiation material layers are respectively attached to outer side surfaces of the two heating layers, and the heating layers located at both ends of the substrate through hole and the infrared radiation material layers on which the heating layers are attached are combined into an infrared radiation unit, wherein the infrared radiation unit is suspended at an outer opening of the substrate through hole, and the heating layers in the infrared radiation unit extend outward and form a support arm connected to the heating layers at the outer edge of the substrate through hole.

7. The gas sensor based on NDIR detection according to claim 6, wherein each of the infrared radiation material layers is a nano-platinum black layer, nano-black silicon layer, carbon nanotube layer, graphene layer, amorphous carbon film doped with metal elements, Au/Al₂O₃/Au metasurface material layer, or ZnNiP chemical plating.

8. The gas sensor based on NDIR detection according to claim 1, wherein the silicon substrate is a monocrystalline silicon substrate or an SOI substrate.

9. The gas sensor based on NDIR detection according to claim 1, wherein the heating layer comprises a support layer, a heating electrode, and an isolation layer that are arranged in a stacked manner; and the heating electrode is a metal composite film layer made of one or more materials selected from the group consisting of Pt, Au, W, Al, tin nitride, nickel-chromium alloy, and MoSi₂, or a polycrystalline silicon film doped with B by ion implantation; and
the support layer and the isolation layer can be a SiO₂ layer, a Si₃N₄ layer, a SiNx layer, or a composite film layer formed by multiple film layers selected from the group consisting of a SiO₂ layer, a Si₃N₄ layer, and a SiNₓ layer.

10. The gas sensor based on NDIR detection according to claim 1, wherein inner and outer surfaces of the base are electroplated with a metal film layer, and the metal film layer is made of one or more materials selected from the group consisting of Ni, Au, Al, and Pt.
